(19) United States
(12) Patent Application Publication
(10) Pub. No.: US 2007/0047846 A1
(43) Pub. Date: Mar. 1, 2007

(54) Handwriting input system and method thereof

(75) Inventors: Kai-Wu Li, Shanghai City (CN); David Ho, Taipei (TW)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/510,782

(22) Filed: Aug. 28, 2006

(30) Foreign Application Priority Data
Aug. 29, 2005 (TW) 94129560

(51) Int. Cl. G06K 9/20

(52) U.S. Cl. 382/312

(57) ABSTRACT

A handwriting input system includes an input module for receiving a plurality of handwriting operations, a control module for displaying at least one handwritten character via an optional interface, wherein the handwritten character is generated according to a respective one of the handwriting operations and a comparing module for recognizing the handwritten character in order to generate a corresponding command.

### FIELD OF THE INVENTION

The invention relates to a handwriting input system and method, and more particularly to the handwriting input system having an input module for receiving a handwritten character in order to generate a corresponding command for instantly executing a system function corresponding to the command.

### BACKGROUND OF THE INVENTION

FIG. 1 shows a conventional personal key system 15 for use in a hand-held device 16 having a handwriting function. The hand-held device 16 is a mobile phone. The conventional personal key system 15 accordingly includes an output unit 11, an input unit 12, a connecting unit 13 and an executing unit 14. The output unit 11 includes a display, such as a screen, to enable the user to watch the information or input an instruction therein. The input unit 12 includes an input device, such as an optional function list in the display, to enable the user to conduct selection of a system function. The connecting unit 13 includes a memory device 131 and a processor 132. For configuring a personal hotkey system, the optional function list is called out from the memory device 131, a hotkey and a system function are selected by pressing the optional function list. Upon receipt of the instructions, the input unit 12 inputs the message into the processor 132 for undergoing a connection operation in order to establish and store the configuration of the personal key system within the memory device 131. Under this condition, the executing unit 14 is capable of fetching the configuration of the personal key system from the memory device 131, and enables the central processing unit 141 to execute the corresponding system function based on the hotkey.

FIG. 2 illustrates a prior art method for configuring an personal hotkey system. The prior art method includes: (S21) entering into an individual mode for configuring a hotkey system; (S22) requesting display of an optional function list on a handwriting screen; (S23) clicking the function list to select a specific hotkey and a system function; (S24) connecting operation being conducted according the specific hotkey and the system function; (S25) configuring and storing a personal hotkey system after the connecting operation; and (S26) finishing the configuration of the personal hotkey system.

In the aforementioned personal hotkey system, the hotkeys are configured or setup in accordance with the user's habit such that when the user wishes to enter into a certain system function of the mobile phone, he or she can quickly connect to the specific system function, thereby avoiding the problems of multiple pressing operations of the keys and resulting in time saving. Though the aforesaid personal hotkey system makes the operation of the mobile phone relatively simple, there still exist some disadvantages. For instance, in case the user is setting up a relatively large volume of the hotkeys in the mobile phone, the user is forced to memorize and thus remember each and everyone of that relatively large volume of the hotkeys. Failure to memorize and remembrance of a single one of the hotkeys may cause the user to give up the facilitation resulted by implementation of the specific hotkey. Under this condition, he is put in a condition to use the mobile phone in the original way, i.e. no hotkey is available.

### SUMMARY OF THE INVENTION

Therefore, it is the object of the present invention to provide a handwriting input system and the method thereof. The handwriting input system includes a comparing module, a control module and an input module for receiving a handwriting operation. Upon entering an optional interface, the comparing module generates a command corresponding to a system function after comparing and recognizing the handwriting operation so that the control module activates the hand-held device to instantly execute the system function.

According to the present invention, a handwriting input system is provided for using in a hand-held device having a handwriting function. The handwriting input system accordingly includes: (a) an input module for receiving a plurality of handwriting operations; (b) a control module for displaying at least one handwritten character via an optional interface, wherein the handwritten character is generated according to a respective one of the handwriting operations; and (c) a comparing module for recognizing the handwritten character in order to generate a corresponding command.

In a second aspect of the present invention, a handwriting input method is provided for using in a hand-held device having a handwriting function. The handwriting input method includes: (a) receiving a first input operation; (b) displaying an optional interface; (c) receiving a second input operation in order to generate a handwritten character once the optional interface enters into a quick optional mode; and (d) comparing and recognizing the handwritten character in order to generate a corresponding command.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a block diagram illustrating a prior art personal hotkey system;

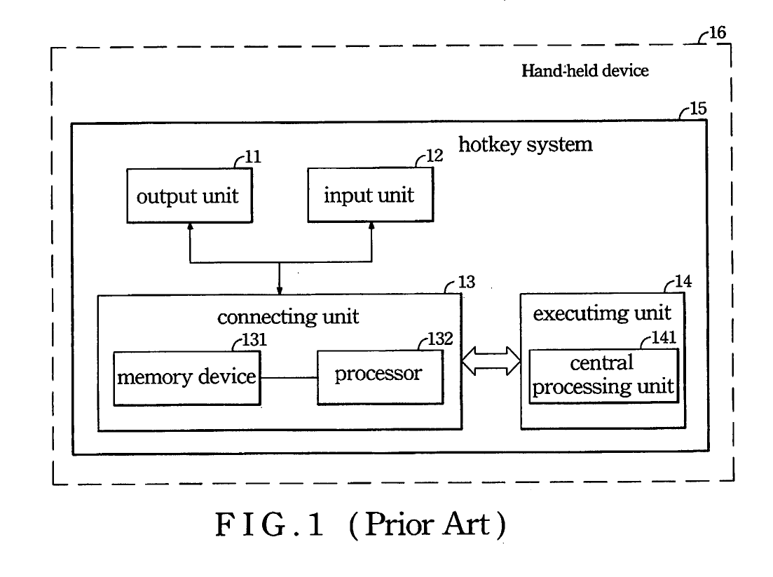

FIG. 2 illustrates the steps in a prior art method for configuring an personal hotkey system;

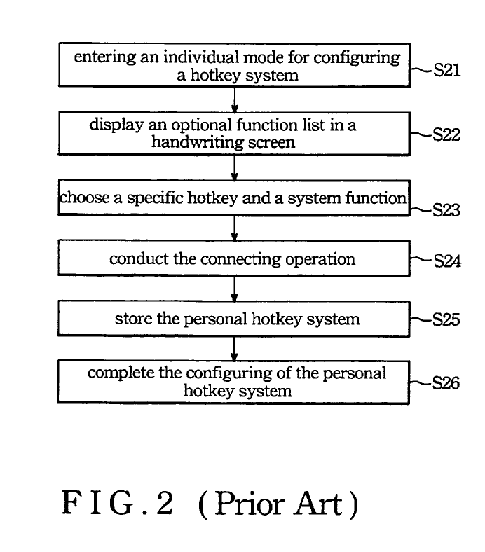

FIG. 3 is a block diagram illustrating a hand-held device provided with a handwriting input system of the present invention;

FIGS. 4a, 4b, 4c and 4d respectively illustrate the schematic representation of the handwriting input system of the present invention;

FIG. 5 illustrates the utilization steps in the handwriting input method of the present invention; and

FIG. 6 illustrates the steps in the handwriting input method of the present invention.

### DETAILED DESCRIPTIONS OF THE PREFERRED EMBODIMENTS

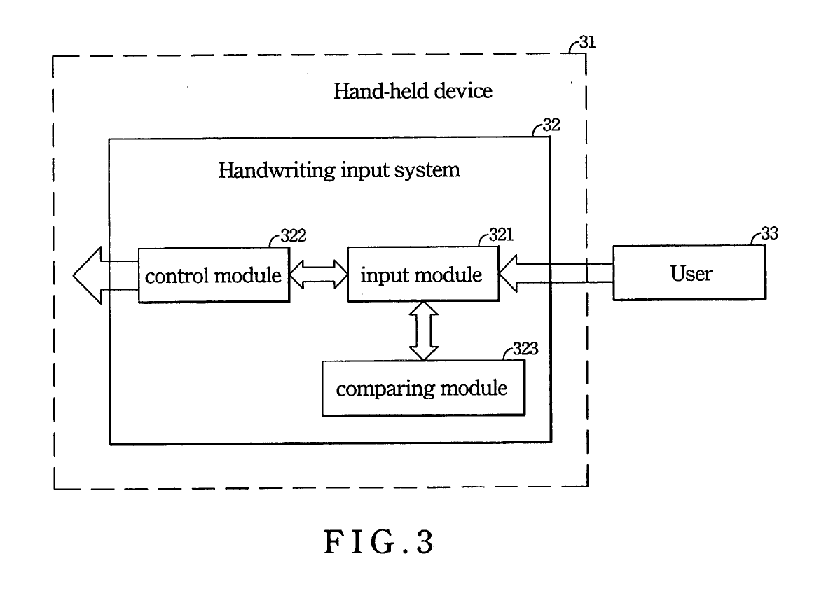

FIG. 3 shows an embodiment of the handwriting input system 32 for inputting a handwriting according to the present invention. The handwriting input system 32 is used in a hand-held device 31 having handwriting function ability. The hand-held device 31 can be a mobile phone, a PDA (personal digital assistant), a tablet PC (personal computer), a UMPC (ultra-mobile personal computer) or any portable electronic device. The handwriting input system 32 accordingly includes an input module 321, a control module 322 and a comparing module 323.

The input module 321 is installed within the mobile phone, and includes a handwriting screen or a touch detecting unit (such as touch keys or touch panel). A handwriting screen serves as the input module 321 in the handwriting input system 32 of the present invention. The control module 322 is installed within the mobile phone, and includes a micro control chip. The control module 322 provides an optional interface 42 on the handwriting screen. If the input module 321 does not include the handwriting screen, the optional interface 42 is displayed over any other display device. The user 33 can choose one system function by clicking the optional interface 42, which, in turn, results in an input operation so as to generate a handwritten character. The comparing module 323 compares and, upon recognizing the handwritten character, outputs a corresponding command to the input module 321 to generate a corresponding system function. The user can confirm the system function by clicking the hotkey (i.e. the handwritten character). Upon receipt of the command, the control unit 322 is enabled and activates the hand-held device 31 to execute the system function instantly.

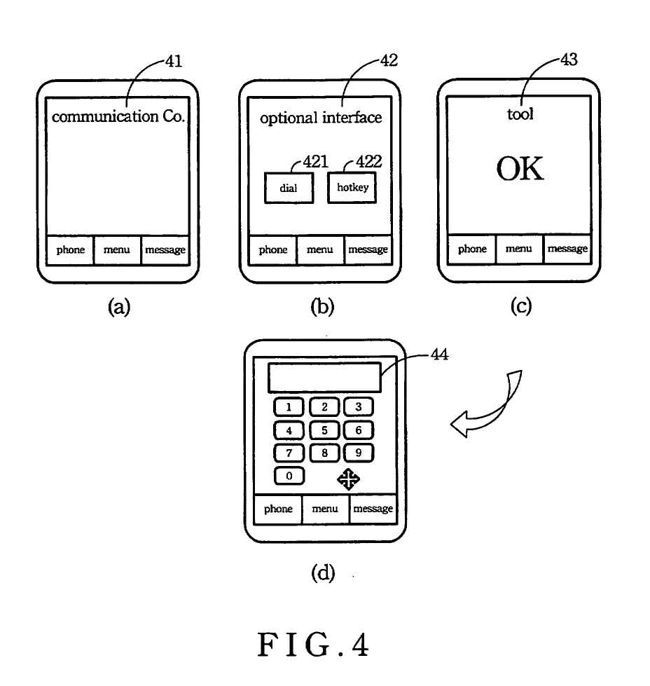

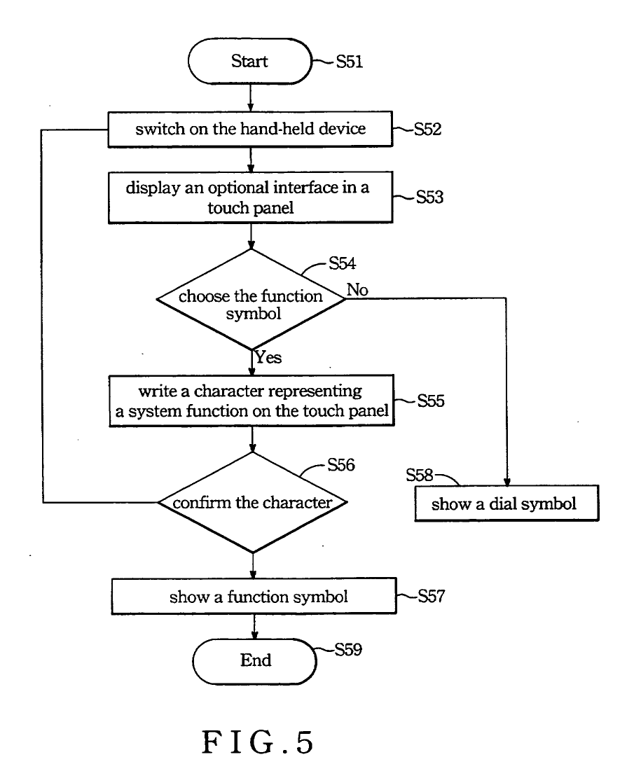

Referring to FIGS. 4a, 4b, 4c and 4d respectively illustrate the steps of utilizing the handwriting input system 32 of the present invention. FIG. 5 illustrates the utilization steps in the handwriting input method of the present invention, and described in the following paragraphs.

The touch panel 41 in the hand-held device 31 is generally switched on at the normal condition or is disposed under the power saving mode. For using the hand-held device 31, the user enters from the beginning step (S51) into the touch panel 41 by switching (or touching) the same into a standby mode (S52), as shown in FIG. 4a. Referring to FIG. 4b and according to the step (S53): an optional interface 42 is displayed on the touch panel 41 upon touching the latter by means of a stylus 401 or any other equivalent elements. The optional interface 42 may include a symbol 421 for dialing a phone number and a shortcut symbol 422 for optionally selecting of a system function. The symbols in the optional interface 42 may differ depending on different types and the desired purposes of the hand-held device 31. A symbol 43 representing “tool” for the system function can be added in the optional interface 42. Addition of the symbol 43 in the optional interface 42 (or change of any symbol) can be accomplished by handwriting operation on the touch panel 41. The user must decide whether he chooses the function symbol 422 by clicking the symbol or not, according to the step (S54). In the step (S58): if the user does not choose the function symbol 422, the input system of the present invention converts the hand-held device 31 into a mobile phone so that dialing of a phone number can be conducted.

As shown in FIG. 4c, in case the user touches the function symbol 422 by means of the stylus 401, an “OK” or a “Cancel” key will appear in the tool 43. In the event, the user wishes to make some calculation and thus a “calculator” function is required, he can enter into the step (S55) using the stylus 401 and writing the character “calculator” on the touch panel. At this time, the touch panel will show the writing traces or strokes and after the recognizing operation the corresponding handwritten character “calculator”. According to the step (S56): if the corresponding handwritten character is correct and matches with the desired system function, the user is to make the confirmation by pressing the “OK” key. The process returns to the step (S52), in which the optional interface 42 is displayed in the touch panel in case no confirmation is made since the corresponding handwritten character does not match the desired system function. Referring to FIG. 4d and according to the step (S57), if the user presses the “OK” key (i.e. upon confirming of the handwritten character), the touch panel displays the operation interface 44 with a plurality function keys. Choosing one of the function keys brings the input method to an end (S59).

Similar to the aforementioned method, the user can personally setup the input system for an individual use. For instance, a handwritten character “ [symbol] ” can be setup to represent the symbol of a calculation function in the function system. Under this condition, in case the user inputs the handwritten character “ [symbol] ” in the following operation, the input module 321 will transmit the symbol “ [symbol] ” to the control unit 322, which compares the symbol “ [symbol] ” with respect to the writing traces or strokes of the already setup handwritten character. Upon confirmation the calculation function, the control module 322 is enabled for instantly executing the calculation operation, i.e. a calculating interface is shown in the touch panel to permit the user to conduct the calculating operation.

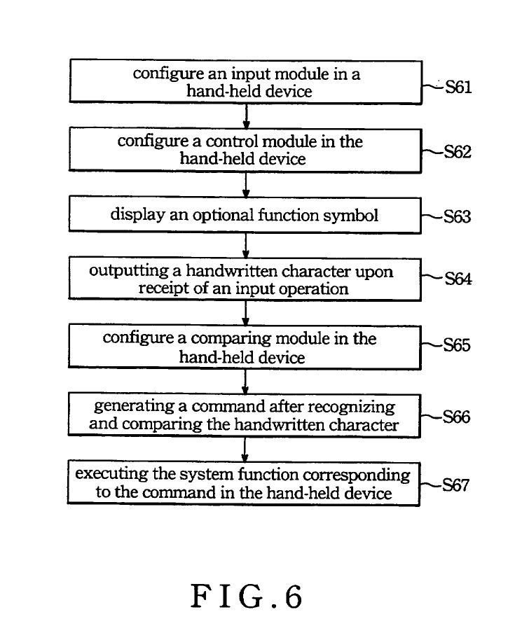

FIG. 6 is a block diagram illustrating the steps of the handwriting input method of the present invention. According to the step (S61): an input module 321 is configured within a hand-held device 31. In accordance with the step (S62): a control module 322 is also configured within the hand-held device 31 such that the former provides an optional interface 42 to be displayed in the input module 321 according to the step (S63). In the step (S64): the input module 321 outputs a handwritten character upon receipt of an input operation, which is resulted when the user clicks a portion of the optional interface 42 by means of a stylus 401. According to the step (S65): a comparing module 323 is configured in the hand-held device 31. In the step (S66): in response to the input operation and after conducting the comparing operation and recognizing the handwritten character, the comparing module 323 generates and transmits a command corresponding to a system function to the control module 322. According to the step (S67): once the user clicks a portion of the optional function interface, the input module 321 is activated by the control module 322, and therefore inputs the command so that a specific system function corresponding to the command is executed within the hand-held device 31.

In the aforesaid input method of the present invention, the user can input a handwriting operation so as to result in a command corresponding to a system function for instantly executing the system function in the hand-held device 31. In contrast to the prior art hotkey input system, the user is not required to memorize and thus remember the symbols representing the system functions. The object is accordingly achieved.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A handwriting input system for a hand-held device having a handwriting function, comprising:
an input module for receiving a plurality of handwriting operations;
a control module for displaying an optional interface having the handwriting function and for converting handwriting operations into at least one handwritten character; and
a comparing module for recognizing said handwritten character in order to generate a corresponding command.

2. The handwriting input system according to claim 1, wherein said hand-held device is a mobile phone.

3. The handwriting input system according to claim 1, wherein said input module includes a handwriting screen for receiving said plurality of handwriting operations.

4. The handwriting input system according to claim 1, wherein said control module includes a micro control chip.

5. The handwriting input system according to claim 1, wherein said optional interface includes a symbol for dialing a phone number or a shortcut symbol for optionally selecting of a system function.

6. The handwriting input system according to claim 1, wherein said command is used for instantly executing said system function.

7. A handwriting input method for a hand-held device having a handwriting function, comprising:
(a) receiving a first input operation;
(b) displaying an optional interface;
(c) receiving a second input operation in order to generate at least one handwritten character once said optional interface enters into a quick optional mode; and
(d) comparing and recognizing said handwritten character in order to generate a corresponding command.

8. The handwriting input method according to claim 7, wherein the hand-held device is a mobile phone.

9. The handwriting input method according to claim 7, wherein said input module includes a screen for receiving said plurality of handwriting operations.

10. The handwriting input method according to claim 7, wherein said control module includes a micro control chip.

11. The handwriting input method according to claim 7, wherein said optional interface includes a dial symbol for dialing a phone number or a shortcut symbol for instantly selecting a system function.

12. The handwriting input method according to claim 7, wherein said command is used for instantly executing said system function.
